(19) United States
(12) Patent Application Publication
(10) Pub. No.: US 2009/0146914 A1
(43) Pub. Date: Jun. 11, 2009

(54) DISPLAY APPARATUS AND METHOD FOR DISPLAYING 3-DIMENTIONAL IMAGE

(75) Inventors: Hwa-seok SEONG, Suwon-si (KR); Jong-sul MIN, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/144,760

(22) Filed: Jun. 24, 2008

(30) Foreign Application Priority Data
Dec. 5, 2007 (KR) 10-2007-0125591

(51) Int. Cl. G09G 5/00

(52) U.S. Cl. 345/6; 345/419

(57) ABSTRACT

A display apparatus and method for displaying a 3D image using a left-eye image signal and a right-eye image signal are provided. The display apparatus includes an image signal division unit which divides an image signal into a plurality of subfields, and a control unit which arranges the plurality of subfields according to luminance weights of the plurality of subfields. Accordingly, the user can be provided with 3D images having high tone and high image quality while preventing the occurrence of double images.

### CROSS-REFERENCE TO RELATED APPLICATIONS

This application claims priority from Korean Patent Application No. 10-2007-0125591, filed on Dec. 5, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to displaying a three-dimensional (3D) image and more particularly, to displaying a 3D image using a left-eye image signal and a right image signal.

2. Description of the Related Art

Developments of flat panel displays such as liquid crystal displays (LCDs), field emission displays (FEDs), and plasma display panels (PDPs) has been very active in recent times. Among such flat panel displays, the PDP has the advantage of combining comparatively high brightness, high luminous efficiency, and a wide viewing angle.

The PDP divides input image signal data of a single frame into a plurality of subfields having different discharge terms, and expresses tone by combining the subfields.

As 3D stereoscopic image technology has been researched around the world, methods for displaying 3D images have been provided. Methods for displaying 3D images are divided into a goggle-type method and a non-goggle-type method.

The goggle-type display method uses binocular parallax, wherein images provided on a display are synchronized with turning both eyes of the goggles on or off, so images observed by each eye at different angles are interpreted by the brain as showing objects in 3D space.

In the case of the goggle-type display method, in order to view 3D images using a PDP in a time division tone expressing method, a left-eye image signal and a right-eye image signal must be input in sequence.

However, since a left-eye image signal and a right-eye image signal are input rapidly in sequence to the PDP, a luminance component generated by the PDP during discharge of a left-eye image is recognized during discharge of a right-eye image, resulting in the occurrence of double images from the user's viewpoint. Furthermore, in a high tone area, a display panel is discharged incorrectly and tone may be degraded, so the quality of images deteriorates.

Therefore, there is a need for methods to solve the above-noted problems.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

An aspect of the present invention provides a display apparatus and method for displaying a 3D image by dividing a 3D image signal into a left-eye image signal and a right-eye image signal.

According to an exemplary aspect of the present invention, there is provided a display apparatus including an image signal division unit which divides an image signal into a first image signal and a second image signal, and divides at least one of the first image signal and the second image signal into a plurality of subfields, and a control unit which divides the plurality of subfields according to luminance weights of each of the plurality of the subfields and arranges the subfields having comparatively low luminance weights and subfields having comparatively high luminance weights alternately.

The first image signal may be an image signal to be viewed by a left-eye, and the second image signal may be an image signal to be viewed by a right-eye.

The control unit may arrange the subfields having comparatively low luminance weights in ascending order, and the subfields having comparatively high luminance weights in descending order.

The control unit may place a subfield having the lowest luminance weight at the beginning, and place a subfield having the second lowest luminance weight subsequent to the subfield having the lowest luminance weight.

At least one of the arranged subfields may be a non-light-emitting subfield.

The control unit may arrange the subfields in the manner that at most one non-light-emitting subfield is placed between light-emitting subfields.

The display apparatus may further include a storage unit which stores information regarding a grayscale tone which can be expressed as a light-emitting subfield from among the plurality of the subfields, and a dithering unit which performs dithering to express a tone which cannot be expressed as the light-emitting subfield from among the plurality of the subfields using the information stored in the storage unit.

At least one of the subfield having the lowest luminance weight and the subfield having the second lowest luminance weight may be not included in the non-light-emitting subfield.

The image signal may be a 3D image signal.

According to another exemplary aspect of the present invention, there is provided a display method including dividing an image signal into a first image signal and a second image signal, dividing at least one of the first image signal and the second image signal into a plurality of subfields, dividing the plurality of subfields according to luminance weights of each of the plurality of the subfields, and arranging subfields having comparatively low luminance weights and subfields having comparatively high luminance weights alternately.

The first image signal may be an image signal to be viewed by a left-eye, and the second image signal is an image signal to be viewed by a right-eye.

In the arranging operation, the subfields having comparatively low luminance weights may be arranged in ascending order, and the subfields having comparatively high luminance weights may be arranged in descending order.

In the arranging operation, a subfield having the lowest luminance weight may be placed at the beginning, and a subfield having the second lowest luminance weight may be placed subsequently in a second position.

At least one of the arranged subfields may be a non-light-emitting subfield.

In the arranging operation, at most one non-light-emitting subfield may be arranged between light-emitting subfields.

The display method may further include storing information regarding a grayscale tone which can be expressed as a light-emitting subfield from among the plurality of the subfields, and performing dithering to express a tone which cannot be expressed as the light-emitting subfield from among the plurality of the subfields using the information stored in the storage unit.

At least one of the subfield having the lowest luminance weight and the subfield having the second lowest luminance weight may be not included in the non-light-emitting subfield.

The image signal may be a 3D image signal.

### BRIEF DESCRIPTION OF THE DRAWINGS

The above and/or other aspects of the present invention will become apparent and more readily appreciated from the following description of the exemplary embodiments of the present invention with reference to the accompanying drawings, in which:

FIG. 1 is a block diagram of an exemplary digital television to which the present invention is applied;

FIG. 2 is a detailed block diagram of an image processing unit of the exemplary digital television of FIG. 1;

FIG. 3 is a schematic plane diagram of a driving unit and a display panel according to an exemplary embodiment of the present invention;

FIG. 4 is a structure of left-eye and right-eye image subfields according to an exemplary embodiment of the present invention;

FIG. 5 illustrates information regarding a subfield discharge rule according to an exemplary embodiment of the present invention; and

FIG. 6 is a flowchart illustrating a display method according to an exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, like drawing reference numerals are used for like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail.

FIG. 1 is a block diagram of an exemplary digital television (DTV) 100 to which the present invention is applied. The DTV 100 includes an image receiving unit 110, an image processing unit 120, a driving unit 130, a display panel 140, a control unit 150, a storage unit 160, a transmission unit 170, and a goggle unit 180.

The image receiving unit 110 receives 3D image signals from an external device connected via a wire or wirelessly thereto or 3D image signals stored in a storage medium within the DTV 100. A 3D image signal contains a left-eye image signal and a right-eye image signal, wherein the left-eye image signal is a signal of an image viewed by the left-eye of a user, and the right-eye image signal is a signal of an image viewed by a right-eye of a user. The image receiving unit 110 transmits the received image signals to the image processing unit 120.

The image processing unit 120 performs division, decoding, and scaling of the 3D image signals received from the image receiving unit 110.

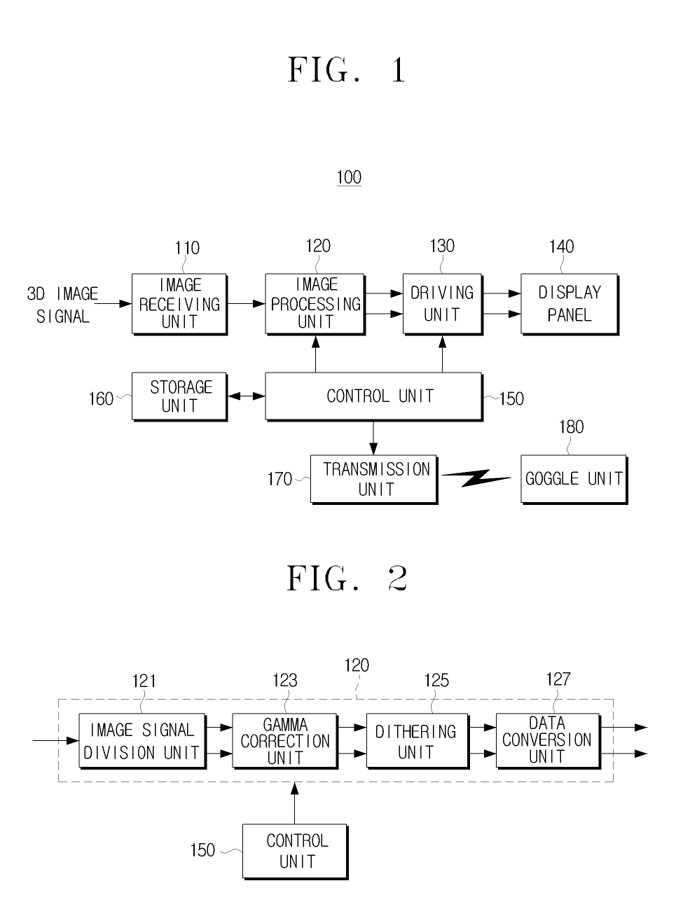

Hereinafter, the operation of the image processing unit 120 is described in detail with reference to FIG. 2.

FIG. 2 is a detailed block diagram of the image processing unit 120. The image processing unit 120 includes an image signal division unit 121, a gamma correction unit 123, a dithering unit 125, and a data conversion unit 127.

The image signal division unit 121 divides a 3D image signal into a left-eye image signal and a right-eye image signal for each field of the 3D image signal. Accordingly, if a single field of a 3D image signal has a 120 Hz frequency, the divided left-eye and right-eye image signals each have a 60 Hz frequency.

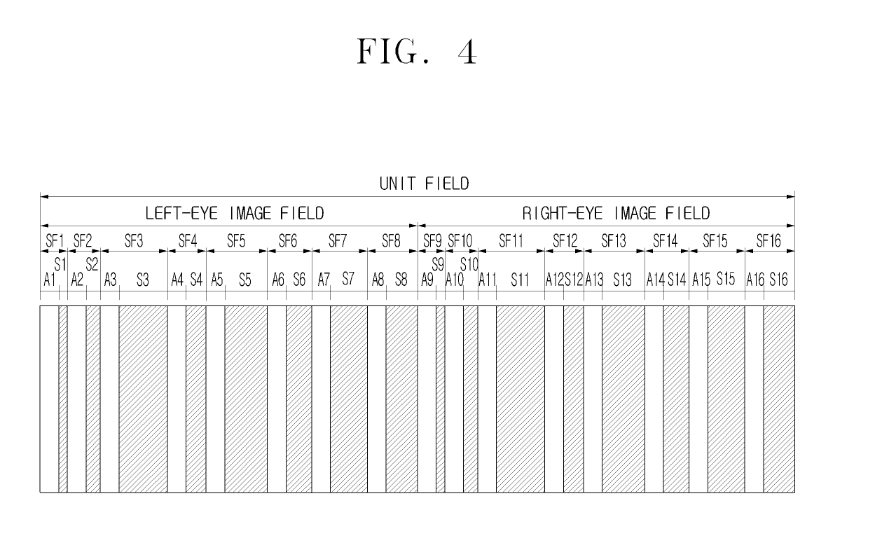

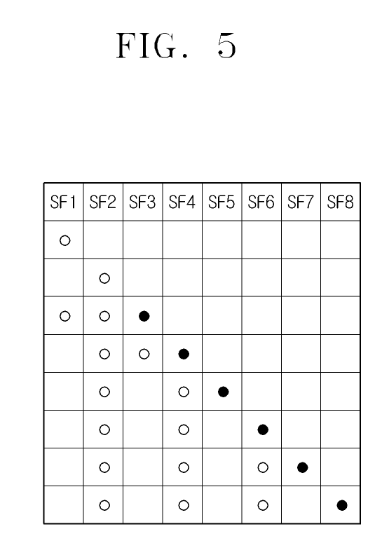

In addition, the image signal division unit 121 divides the left-eye and right-eye image signals into a plurality of subfields, as discussed in more detail below with reference to FIG. 4.

The image signal division unit 121 outputs the left-eye and right-eye image signals, which are divided into a plurality of subfields, to the gamma correction unit 123.

The gamma correction unit 123 performs inverse-gamma correction of input image signal data using pre-stored inverse-gamma data, so the luminance of the signal changes linearly according to the tone of an image signal. The gamma correction unit 123 diffuses errors generated by inverse-gamma correction and outputs the diffused errors to the dithering unit 125.

For example, the gamma correction unit 123 performs inverse-gamma correction of an input signal using an equation such as Y=X^{2.2} (where X is an input signal, and Y is an output signal), and weights an error down to one decimal place, to be reflected in the luminance of neighboring pixels and adds the weighted error to the neighboring pixels.

The dithering unit 125 dithers the inverse-gamma-corrected image signal using available tones which are stored in a tone chart which is pre-selected according to a subfield discharge rule.

That is, the dithering unit 125 expresses the input tone using the output tone, which is different from the input tone. The input tone is a tone which is designated to be expressed on the display, and the output tone is available tone which is stored in the tone chart.

For example, if an input tone is designated as 8, the dithering unit 125 performs dithering in order to output three tones of 0 and one tone of 32 in each unit of a 2×2 area, respectively. Accordingly, the average tone in the 2×2 area is 8, so the input tone of 8 can be expressed using output tones of 0 and 32.

Subsequently, the dithering unit 125 outputs the dithered left-eye and right-eye image signals to the data conversion unit 127.

The data conversion unit 127 converts the dithered signal into a signal to drive the display panel 140, and outputs the converted signal to the driving unit 130.

Returning to FIG. 1, the driving unit 130 receives the left-eye and right-eye image signals, and drives the display panel 140 to display the left-eye and right-eye image signals.

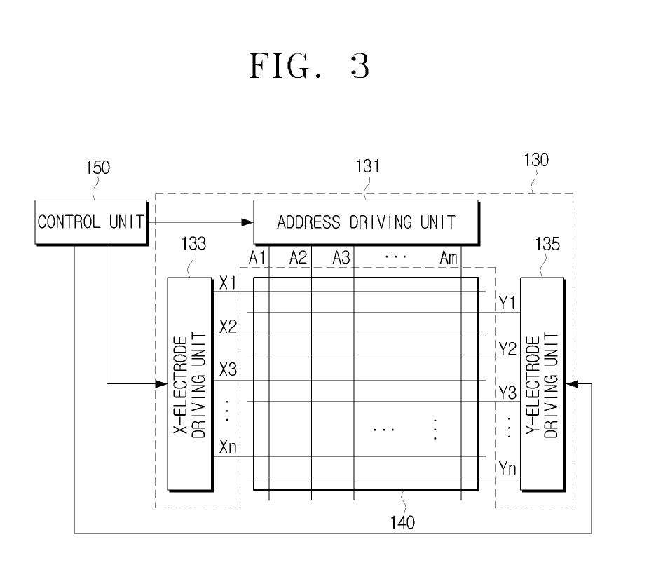

The display panel 140 is driven by the driving unit 130 and provides the user with 3D images. The specific operation of the driving unit 130 and the display panel 140 is described with reference to FIG. 3.

FIG. 3 is a schematic plane diagram of the driving unit 130 and the display panel 140 according to an exemplary embodiment of the present invention, and illustrates the driving unit 130 and the display panel 140 together with the control unit 150 for convenience of description. As shown in FIG. 3, the driving unit 130 according to an exemplary embodiment of the present invention includes an address driving unit 131, an X-electrode (sustain electrode) driving unit 133, and a Y-electrode (address electrode) driving unit 135.

The display panel 140 includes a plurality of address electrodes A1 to Am which are arranged vertically in parallel, and a plurality of X-electrodes (X1 to Xn) and Y-electrodes (Y1 to Yn) which are arranged horizontally in pairs in parallel. Accordingly, each X-electrode corresponds to a Y-electrode.

The display panel 140 consists of a substrate (not shown) on which the X-electrodes and Y-electrodes are arranged, and a substrate (not shown) on which the address electrodes are arranged. The two substrates face each other and have a discharge space therebetween, so that the X-electrodes cross at right angles to the address electrodes and the Y-electrodes cross at right angles to the address electrodes as well. The discharge space formed by the X-electrodes, Y-electrodes, and address electrodes form discharge cells.

In greater detail, the address driving unit 131 receives an address electrode driving control signal from the control unit 150 and transmits a display data signal to each address electrode to select discharge cells to be displayed. The X-electrode driving unit 133 receives an X-electrode driving control signal from the control unit 150 and transmits driving voltage to the corresponding X-electrodes. The Y-electrode driving unit 135 receives a Y-electrode driving control signal from the control unit 150 and transmits driving voltage to the corresponding Y-electrodes.

As described above, the X-electrode driving unit 133 and Y-electrode driving unit 135 receive control signals from the control unit 150, and input sustain voltage to X-electrodes and Y-electrodes alternately so that sustain discharge for selected discharge cells can be performed.

Returning to FIG. 1, the transmission unit 170 receives from the control unit 150 information regarding whether an image signal to be displayed is a left-eye image signal or a right-eye image signal.

Subsequently, the transmission unit 170 transmits to the goggle unit 180 a goggle driving signal containing the information regarding whether an image signal to be displayed is a left-eye image signal or a right-eye image signal. The goggle driving signal also contains information regarding the time that the image signal is displayed on the display panel.

The goggle unit 180 receives the goggle driving signal from the transmission unit 170. The lenses of the goggle unit 180 are opened and closed according to the goggle driving signal. More specifically, if a left-eye image signal is displayed, the left lens of the goggle unit 180 is opened and the right lens is closed. If a right-eye image signal is displayed, the left lens of the goggle unit 180 is closed and the right lens is opened.

Accordingly, the operation of opening and closing the lenses must coincide with the period of displaying a left-eye image and right-eye image on the display panel 140. That is, if a left-eye image signal and a right-eye image signal each have a frequency of 60 Hz, the left and right lenses of the goggle unit 180 each also have a frequency of 60 Hz.

By this operation of the goggle unit 180, the user can see an image displayed by a left-eye image signal using the left-eye and an image displayed by a right-eye image signal using the right-eye, alternately. As a result, the user can feel the sense of viewing in a 3D space.

The control unit 150 controls the overall operation of the DTV 100. The control unit 150 operates the image processing unit 120 to perform division, decoding, and scaling of 3D image signals.

The control unit 150 outputs the address driving control signal, X-electrode driving control signal, and Y-electrode driving control signal to the driving unit 130 in order to control the driving unit 130.

The control unit 150 controls the image processing unit 120 to divide a unit field into a left-eye image field and a right-eye image field, and divide the left-eye image field and right-eye image field into a plurality of subfields.

The control unit 150 transmits to the transmission unit 170 information regarding whether an image signal to be displayed on the display panel 140 is a left-eye image signal or a right-eye image signal.

The control unit 150 divides the plurality of subfields according to a luminance weight, and controls subfields having a comparatively low luminance weight and subfields having a comparatively high luminance weight to be arranged alternately.

FIG. 4 is a structure of a left-eye and right-eye image subfield according to an exemplary embodiment of the present invention.

As shown in FIG. 4, the control unit 150 divides a unit field into a left-eye image field and a right-eye image field, and divides the left-eye image field and the right-eye image field into a plurality of subfields SF1 to SF8 and SF9 to SF16, respectively. Each of the plurality of the subfields has a respective luminance weight in order to express tones. In this exemplary embodiment, the left-eye image field and the right-eye image field each have 8 subfields SF1 to SF8 and SF9 to SF16, with luminance weights of 1, 2, 128, 4, 64, 8, 32, and 16, respectively.

Each subfield consists of a reset time (not shown), an addressing time A1 to A16, and a sustain time S1 to S16 according to operation change overtime.

The reset time is a time for initializing the state of each cell in order to smoothly perform addressing operation of the cell. The addressing time is a time for accumulating wall charges by applying address voltage to lit cells (addressed cells) so as to divide lit cells and unlit cells on the display panel 140. The sustain time is a time for discharging wall charges by applying sustain discharge pulses to addressed cells so as to display images using the addressed cells.

Since the left-eye image field and the right-eye image field each have 8 subfields SF1 to SF8 and SF9 to SF16 with luminance weights of 1, 2, 128, 4, 64, 8, 32, and 16, respectively, the sustain times S1 to S8 and S9 to S16 have discharge ratios of 1:2:128:4:64:8:32:16, respectively.

The control unit 150 firstly arranges a subfield SF1 having 1 luminance weight, and then according to the luminance weight, arranges a subfield having the lowest luminance weight and a subfield having the highest luminance weight, and arranges a subfield having the next lowest luminance weight and a subfield having the next highest luminance weight, alternately.

That is, the control unit 150 arranges the subfields in the order that subfields having comparatively low luminance weights are arranged in ascending order and subfields having comparatively high luminance weights are arranged in descending order.

Therefore, the order of the luminance weights of the 8 subfields SF1 to SF8 and SF9 to SF16 of the left-eye image field and the right-eye image field may be 1, 2, 128, 4, 64, 8, 32, and 16, respectively.

If the subfields are arranged in this manner, a subfield having a comparatively low luminance weight can induce discharge of a subfield having a comparatively high luminance weight. That is, in the reset time, the state of each cell is initialized in order to smoothly perform the addressing operation of the cell, but advantageous conditions for discharging a subsequent subfield can be made since a part of the wall charge generated in the sustain time of the previous subfield remains.

The control unit 150 generates information regarding a subfield discharge rule which meets advantageous conditions for such a discharge, and stores the information in the storage unit 160.

The detailed description above is given with reference to FIG. 5, which illustrates information regarding the subfield discharge rule according to an exemplary embodiment of the present invention.

In FIG. 5, the white dots indicate subfields which induce discharge, and the black dots indicate subfields to be discharged.

Firstly, a method for expressing tone is described. Desired tones can be expressed by summing up different luminance weights of subfields.

For example, in order to express a tone of 3, discharge cells in a subfield SF1 having a luminance weight of 1 and a subfield SF2 having a luminance weight of 2 are discharged, so the sum of the discharged time, that is, the sum of the luminance weights, is 3.

The control unit 15 combines subfields having different discharge times in this manner so that the total of 256 tones including tone of 0 can be displayed on the display panel 140.

Next, a method for generating preferred and/or advantageous conditions for discharging subfields is described, and a left-eye image field is described as an example for convenience of description.

If subfields are divided into two areas according to the luminance weight, the two areas are, firstly, the most significant bit (MSB) subfields SF3, SF5, SF7, and SF8 having comparatively high luminance weights and, secondly, the least significant bit (LSB) subfields SF1, SF2, SF4, and SF6 having comparatively low luminance weights.

Subfield SF1 having the lowest luminance weight is placed first, so subfield SF1 generates preferred condition for discharging another subfield.

After subfield SF1 having the lowest luminance weight is placed, the LSB subfields are arranged in increasing order, and the MSB subfields are arranged therebetween in decreasing order.

This arrangement allows wall charge generated in a previous subfield to be advantageously used to discharge a subsequent subfield. That is, an LSB subfield generates preferred conditions for discharging a subsequently disposed MSB subfield and LSB subfield, and the MSB subfield generates preferred conditions for discharging a subsequently disposed LSB subfield.

Accordingly, FIG. 5 provides a table regarding a subfield discharge rule to generate preferred conditions for discharge, and the control unit 150 controls a desired subfield to be advantageously discharged using the information regarding the subfield discharge rule.

For example, in order to discharge subfield SF6, the control unit 150 generates advantageous condition for discharging subfield SF6 by discharging subfield SF4 which is a previous LSB subfield.

In addition, the control unit 150 generates preferred condition for discharging subfield SF4 by discharging subfield SF2 which is a previous LSB subfield.

In order to discharge subfield SF6, preferred condition for discharging subfield 6 may be generated by discharging subfield SF2 and subfield SF4.

The control unit 150 controls the storage unit 160 to store the subfield discharge rule and information regarding a tone which can be displayed as a light-emitting subfield, as a tone chart. The information regarding the tone which can be displayed as a light-emitting subfield, is information for dithering to display tones which cannot be displayed as light-emitting subfields.

For example, in order to discharge subfield SF6, subfields SF2 and SF4 are discharged according to the subfield discharge rule. If a desired luminance is 13, 13 cannot be generated using subfields SF2, SF4, and SF6.

Therefore, the control unit 150 controls the dithering unit 125 to output two tones of 0 and two tones of 2 in each unit of a 2×2 area, respectively, of the display area, so an average tone of 1 is expressed.

As a result, discharging subfields SF4 and SF6 is induced by discharging subfield SF2, so a tone of 13 can be expressed.

Accordingly, advantageous condition for discharging each subfield can be generated by satisfying the subfield discharge rule, the discharge margin is assured, and tone degradation and double image occurrence can be reduced.

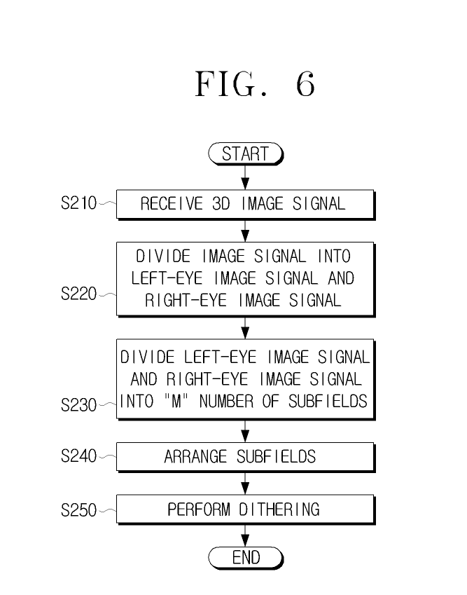

FIG. 6 is a flowchart illustrating a display method according to an exemplary embodiment of the present invention.

Firstly, the image receiving unit 110 receives a 3D image signal from an external device connected to the DTV 100 via a wire or wirelessly, or a 3D image signal which is stored in a recording medium within the DTV 100 (S210).

The image receiving unit 110 transmits the received 3D image signal to the image signal division unit 121, and the image signal division unit 121 divides the image signal into a left-eye image signal and a right-eye image signal for each field of the 3D image signal (S220).

In addition, the image signal division unit 121 divides the left-eye image signal and the right-eye image signal into “m” number of subfields, respectively (S230). Each subfield may have luminance weight of “2m-1” at most. That is, if a left-eye image signal is divided into 8 subfields, wherein the 8 subfields have luminance weights of 1, 2, 4, 8, 16, 32, 64, and 128.

Subsequently, the control unit 150 arranges the subfields following the subfield discharge rule (S240). In more detail, the control unit 150 arranges the subfields in the order of luminance weights 1, 2, 128, 4, 64, 8, 32, and 16.

If the subfields are arranged to provide advantageous conditions for subfield discharging following this process, the control unit 150 controls the operation to express tone using only subfields which are determined according to the subfield discharge rule, and to express subfields, which are not the subfields determined according to the subfield discharge rule, using desired tone on the display by dithering (S250).

Accordingly, preferred and/or advantageous conditions for discharging each subfield can be generated by satisfying the subfield discharge rule, the discharge margin is assured, and tone degradation and double image occurrence can be reduced.

In this exemplary embodiment, the display apparatus processes only 3D image signals, but this is merely an example for convenience of description, and the display apparatus can be implemented to process two dimensional (2D) image signals or audio signals.

In this exemplary embodiment, the image processing unit includes the image signal division unit, the gamma correction unit, the dithering unit, and the data conversion unit, but this is merely an example for convenience of description, so the image signal division unit, the gamma correction unit, the dithering unit, and the data conversion unit can be implemented to be included in the control unit.

In this exemplary embodiment, 8 subfields having luminance weights of 1, 2, 4, 8, 16, 32, 64, and 128 are described to express tone of 128, but this is merely an example for convenience of description. The technical idea of the present invention can be applied even when a tone other than 128 is expressed, luminance weights which differ from the luminance weights of this exemplary embodiment are applied, and different numbers of subfields are applied.

In this exemplary embodiment, a subfield having the lowest luminance weight and a subfield having the second lowest luminance weight are arranged at the beginning, but this can vary within a range of not hurting the technical idea of the present invention. That is, a subfield having the lowest luminance weight may be placed at the beginning, subsequently a subfield having the highest luminance weight may be placed, and the remaining subfields may be placed alternately according to the luminance weight.

The subfield discharge rule shown in FIG. 5 is merely an example for convenience of description. Accordingly, the subfield discharge rule can be set differently according to the user convenience.

As can be appreciated from the above description, the user can be provided with 3D images having high tone and high image quality without double images. Moreover, since discharge margin is assured, the display apparatus can be operated smoothly.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
an image signal division unit which divides an image signal into a first image signal and a second image signal, and divides at least one of the first image signal and the second image signal into a plurality of subfields; and
a control unit which divides the plurality of subfields according to luminance weights of the plurality of the subfields and arranges subfields having comparatively low luminance weights and subfields having comparatively high luminance weights alternately to generate arranged subfields.

2. The display apparatus of claim 1, wherein the first image signal is an image signal to be viewed by a left-eye, and the second image signal is an image signal to be viewed by a right-eye.

3. The display apparatus of claim 1, wherein the control unit arranges the subfields having comparatively low luminance weights in ascending order, and the subfields having comparatively high luminance weights in descending order.

4. The display apparatus of claim 1, wherein the control unit places a subfield having a lowest luminance weight at a beginning, and places a subfield having a second lowest luminance weight after the subfield having the lowest luminance weight.

5. The display apparatus of claim 1, wherein at least one of the arranged subfields is a non-light-emitting subfield.

6. The display apparatus of claim 5, wherein the control unit arranges the plurality of the subfields in the manner that at most one non-light-emitting subfield is placed between light-emitting subfields.

7. The display apparatus of claim 5, further comprising:
a storage unit which stores information regarding a grayscale tone which is expressed as a light-emitting subfield using subfields from among the plurality of the subfields, and
a dithering unit which performs dithering to express a tone which cannot be expressed as a light-emitting subfield using subfields from among the plurality of the subfields based on the information regarding the grayscale tone stored in the storage unit.

8. The display apparatus of claim 5, wherein at least one of the subfield having the lowest luminance weight and the subfield having the second lowest luminance weight is not included in the non-light-emitting subfield.

9. The display apparatus of claim 1, wherein the image signal is a three-dimensional (3D) image signal.

10. A display method comprising:
dividing an image signal into a first image signal and a second image signal;
dividing at least one of the first image signal and the second image signal into a plurality of subfields;
dividing the plurality of subfields according to luminance weights of the plurality of the subfields; and
arranging subfields having comparatively low luminance weights and subfields having comparatively high luminance weights alternately, from among the plurality of the subfields, to generate arranged subfields.

11. The display method of claim 9, wherein the first image signal is an image signal to be viewed by a left-eye, and the second image signal is an image signal to be viewed by a right-eye.

12. The display method of claim 9, wherein in the arranging operation, the subfields having comparatively low luminance weights are arranged in ascending order, and the subfields having comparatively high luminance weights are arranged in descending order.

13. The display method of claim 9, wherein in the arranging operation, a subfield having a lowest luminance weight is placed at a beginning, and a subfield having a second lowest luminance weight is placed after the subfield having the lowest luminance weight in a second position.

14. The display method of claim 9, wherein at least one of the arranged subfields is a non-light-emitting subfield.

15. The display method of claim 13, wherein in the arranging operation, at most one non-light-emitting subfield is arranged between light-emitting subfields.

16. The display method of claim 13, further comprising:
storing information regarding a grayscale tone which is expressed as a light-emitting subfield using subfields from among the plurality of the subfields, and
performing dithering to express a tone which cannot be expressed as a light-emitting subfield using the plurality of the subfields based on the information regarding the grayscale tone stored in the storage unit.

17. The display method of claim 13, wherein at least one of the subfield having the lowest luminance weight and the subfield having the second lowest luminance weight is not included in the non-light-emitting subfield.

18. The display method of claim 10, wherein the image signal is a three-dimensional (3D) image signal.
